(19) United States
(12) Patent Application Publication
(10) Pub. No.: US 2004/0115371 A1
(43) Pub. Date: Jun. 17, 2004

(54) Ink-jet recording sheet

(75) Inventor: Masayuki Ushiku, Yokohama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA HOLDINGS, INC., Tokyo (JP)

(21) Appl. No.: 10/729,230

(22) Filed: Dec. 4, 2003

(30) Foreign Application Priority Data
Dec. 11, 2002 (JP) JP2002-359216

(51) Int. Cl. B32B 3/00

(52) U.S. Cl. 428/32.1

(57) ABSTRACT

An ink-jet recording sheet including a support having thereon an ink receiving layer containing a silica particle prepared by a wet method and a hydrophilic binder, wherein the silica particle has an average diameter of a primary particle of not more than 10 nm and an average diameter of a second particle diameter of 10 to 300 nm; a weight ratio of the silica particle to the hydrophilic binder is 5.5:1 to 12:1; and the ink receiving layer has a surface pH value of 3.0 to 6.0.

### TECHNICAL FIELD

The present invention relates to a high quality ink-jet recording sheet which exhibits excellent glossiness as well as excellent ink absorbability, results in desired image density, minimizes image bleeding after storage of prints, and results in crack resistance of an ink absorptive layer.

### BACKGROUND

In recent years, ink-jet recording has rapidly resulted in improvement of image quality, which is now approaching conventional photographic image quality. As a means to achieve such photographic image quality employing ink-jet recording, technical improvements of ink-jet recording sheets (hereinafter occasionally referred to as recording sheets) have increasingly been achieved. A recording sheet which comprises a support of high smoothness having thereon a layer of a microscopic void structure (hereinafter occasionally referred to as a void layer, an ink absorptive layer, or a porous layer) has resulted in one of recording sheets which produce images which are nearest to conventional photographic quality, due to excellent ink absorbability as well as excellent drying properties. Specifically, when a non-water absorptive support is employed, it is possible to maintain a highly smooth surface due to minimal formation of cockling after printing, whereby it is possible to produce prints of higher quality.

Such a porous layer is comprised mainly of hydrophilic binders and minute particles. Known as such minute particles are minute inorganic or organic particles. Commonly employed are minute silica particles of a smaller size. It is preferable to use as such minute silica particles those of which the surface is anionic, since excellent glossiness is thereby achieved. For example, known is an ink-jet recording sheet which is prepared by combining minute silica particles synthesized by a vapor phase method or colloidal silica with a small amount of hydrophilic binders. Further, in order to minimize bleeding after storage of prints, cation fixing agents such as cationic polymers or multivalent metal salts are commonly employed.

In order to allow an ink absorptive layer incorporating the vapor phase method silica to result in desired bleeding resistance, it is effective to increase the amount of cation fixing agents. On the other hand, problems occur in which mottling and bronzing occur due to degradation of ink absorbability. As a result, it is difficult to simultaneously achieve desired bleeding resistance and also desired ink absorbability.

Known as another means to prepare the ink absorptive layer incorporating a void structure is a method in which porous wet process silica, which is synthesized by a precipitation method or a gelling method, is used. However, the resulting silica is commonly in the form of aggregated particles of a size of several micrometers, and at present, a coating comprising the aforesaid silica does not result in high glossiness. Therefore, known is a method in which a coating of desired glossiness is formed by employing wet process silica particles which have been powdered to result in minute particles. Proposed as one (for example, refer to Patent Document 1) of the examples is an ink-jet recording sheet which employs minute silica particles which are prepared in such a manner that wet process silica synthesized by a precipitation method is powdered to form minute particles, employing a pressure type homogenizer. Further, in order to overcome problems in which, even though the wet process silica which is produced by a precipitation method is powdered into minute particles, sufficient glossiness is not achieved and ink absorbability is degraded, an ink-jet recording sheet is proposed (for example, refer to Patent Document 2) which comprises wet process silica which is prepared by powdering amorphous silica having a specific surface area of at least 150 cm²/g which is prepared using a gelling method and binder resins, while the weight ratio of minute silica particles to binder resins is in the range of 3-5. However, it has been difficult to achieve sufficient ink absorbability even though the aforesaid techniques are employed. Further, a porous layer is formed so that the weight ratio of minute silica particles to binder resins increases. However, the aforesaid ink-jet recording sheet, in which the weight ratio of binder resins to minute silica particles decreases, causing cracking problems which tends to occur during coating and drying, and after forming the ink absorptive layer, when a recording sheet is rolled or folded in dry air, the ink absorptive layer tends to crack.

(Patent Document 1)

Japanese Patent Publication Open to Public Inspection (hereinafter referred to as JP-A) No. 10-272833 (Examples)

(Patent Document 2)

JP-A No. 2001-246830 (claims and Examples)

### SUMMARY

The present invention was achieved to overcome the aforesaid problems. A first objective is to provide an ink-jet recording sheet which exhibits high ink absorbability, high glossiness, high print density, and excellent crack resistance due to formation of a flexible ink absorptive layer. A second objective is to provide a high quality ink-jet recording sheet which also exhibits bleeding resistance.

The aforesaid objectives of the present invention are achieved employing the embodiments described below.

(1) An ink-jet recording sheet wherein an ink absorptive layer comprises minute wet process silica particles of an average diameter of the primary particles of 10 nm or less and of an average diameter of the secondary particles of 10-300 nm, as well as a hydrophilic binder; the weight ratio (F/B) of the aforesaid minute wet process silica particles (F) to the aforesaid hydrophilic binder (B) is 5.5-12; and the pH of the surface of the aforesaid ink absorptive layer is 3.0-6.0.

(2) The ink-jet recording sheet, described in item 1. above, wherein the aforesaid minute wet process silica particles are synthesized employing a gelling method.

(3) The ink-jet recording sheet, described in items 1 or 2 above, wherein the aforesaid hydrophilic binder is polyvinyl alcohol or its derivative.

(4) The ink-jet recording sheet, described in any one of items 1-3 above, wherein the aforesaid ink absorptive layer comprises a cation fixing agent.

(5) The ink-jet recording sheet, described in any one of items 1-4 above, wherein the support is a non-water absorptive support.

The present inventors investigated the above-mentioned problems and found the following knowledge about silica made by a wet method.

The glossiness of the surface of the recoding sheet becomes higher in accordance with a dispersion degree of silica made by a wet method. Highly dispersed silica made by a wet method increases the glossiness, but decreases the void ratio. There is a contradiction between high glossiness and high ink absorbing property.

After investigation of the present inventor, it was found that the above-described embodiment item 1 dissolve the problems.

In an ink-jet recording sheet in which the ink absorptive layer comprised minute wet process silica particles of an average diameter of the primary particles of 10 nm or less and of an average diameter of the secondary particles of 10-300 nm, and the weight ratio (F/B) of the aforesaid minute wet process silica particles (F) to the aforesaid hydrophilic binder (B) is 5.5-12, and the pH of the surface of the ink absorptive layer is 3.0-6.0, the following was discovered. Cracking tended not to occur during coating and drying. It was possible to produce an ink absorptive layer which resulted in compatibility of both high ink absorbability and desired glossiness. Further, even when cation fixing agents were not incorporated, it was possible to achieve high print density. The present invention was thus achieved.

Further, when cation fixing agents are incorporated into the ink absorptive layer constituted as above, the fixing efficiency of coloring agents is enhanced, whereby it is possible to result in bleeding resistance in an amount of the aforesaid cation fixing agents, which does not adversely affect ink absorbability. At present, reasons for enhancement of the dying efficiency due to the aforesaid constitution are not yet clearly understood. However, it is considered that adsorbing components of cation fixing agents to silica particles decreases due to the fact that the wet process silica comprises a markedly small amount of an active independent silanol group compared to the vapor phase silica, whereby free cation components increase.

### DESCRIPTION OF THE PREFERRED EMBODIMENTS

The present invention will now be further detailed.

Wet process silica according to the present invention, as described herein, refers to one which is synthesized by a precipitation method or a gelling-method employing sodium silicate as a raw material. As wet process silica which is synthesized by the precipitation method, commercially available is, for example, Finesil from Tokuyama Corp., while as wet process silica which is synthesized by gelling method commercially available is, for example, Nipgel from Nippon Silica Industrial Co., Ltd. The precipitation method silica is comprised of minute silica particles in the form of secondary aggregates of primary particles of about 10 nm-about 60 nm, while the gelling method silica is comprised of minute silica particles in the form of secondary aggregates of primary particles of about 3 nm-about 10 nm.

Silica made by a wet method is generally made by a precipitation method or a gelling method using mainly sodium silicate as a starting material and changing a condition to produce colloidal silica. An example of the preparation method of a wet method silica is disclosed in a textbook of “The property and application technology of porous materials”, Fuji Technosystem, Co. Ltd. 1999, P 70-71.

When a porous layer is formed employing minute silica particles of a relatively small primary particle diameter which are powdered into further smaller diameter, microscopic voids are easily formed to be advantageous for the fixability of coloring agents. On the other hand, since the specific surface area increases, a relatively large amount of binders is required to achieve the desired coating strength, whereby the ink absorbability degrades. In order to overcome the aforesaid drawbacks, the inventors of the present invention conducted diligent investigations. As a result, it was discovered that by appropriately controlling the pH of the layer surface in the range of 3.0-6.0, it was possible to decrease the amount of binder resins which is required to maintain the coating strength, and to markedly minimize cracking during coating and drying, and further to enhance fixability of coloring agents.

The aforesaid effects are not yet completely understood. However, it is assumed that by approaching the pH of the surface of the formed coating to the isoelectric point of the silica, adhesion due to enhancement of a hydrogen bond is strengthened, whereby cracking is minimized. Further, it is assumed that the fixability of coloring agents is enhanced in such a manner that in addition to a decrease in diameter of primary particles, more microscopic voids are formed due to an increase in aggregation force among silica particles in the aforesaid pH range of the layer surface, whereby high print density results.

Based on the aforesaid investigation results, when the ink-jet recording sheet of the present invention is constituted as described below, an ink absorptive layer is prepared which satisfies all requirements for glossiness, print density, and ink absorbability. Incorporated together with hydrophilic binders are minute wet process silica particles of an average diameter of the primary particles of preferably at most 10 nm, and more preferably at most 8 nm, and of an average diameter of the secondary particles of 10-300 nm. The weight ratio (F/B) of the aforesaid minute wet process silica particles (F) to the aforesaid hydrophilic binders (B) is 5.5-12, and the pH of the surface of the ink absorptive layer is in the range of 3.0-6.0, and is preferably in the range of 3.5-5.5.

The lower limit of the diameter of primary particles of the wet process silica according to the present invention is not particularly limited. However, from the viewpoint of production stability of minute silica particles, the aforesaid diameter is preferably at least 3 nm.

From the viewpoint of achieving higher print density, preferred as the wet process silica according to the present invention is one which is synthesized by a gelling method. The wet process silica which is synthesized by such a gelling method exhibits high aggregation force due to higher surface activity of particles compared to those synthesized by the precipitation method. As a result, more microscopic voids are easily formed whereby it is assumed that higher print density is achieved based on the aforesaid assumed causes.

The average diameter of each of the primary particles and the secondary particles of the wet process silica specified by the present invention is determined as follows. The section and surface of a void layer is observed using an electron microscope. The diameter of 100 randomly selected wet process silica particles are then determined and the resulting values are averaged. Herein, each particle diameter is represented by the diameter of a circle which has the same area as the projection area of the particle.

In order to achieve powdering of wet process silica, it is possible to employ, for example, a high pressure homogenizer, a sand mill, or an ultrasonic homogenizer. Particles of at least 10 μm in the dispersion particle size distribution markedly affect glossiness, transparency and ink absorbing property of the ink absorptive layer. Specifically, it is preferable that Formula (I), described below, is satisfied.

150<y+17·ln(x)<500 Formula (I)

wherein x represents the number of particles of at least 10 μm in one g of the wet process silica, while y represents the average particle diameter of the wet process silica.

When the value of “y+17·ln(x)” satisfy Formula (I), high glossiness, high transparency and high ink absorbing property can be achieved. When the value is less than 150, the recording sheet has only low ink absorbing property even if it achieves high glossiness and high transparency. When the value is more than 500, it is hard to achieve high glossiness and high transparency of the recording sheet.

In order to obtain the dispersion particle size which satisfies above Formula (I), in the present invention, it is preferable to use a sand mill. Preferred as beads employed in the aforesaid sand mill are zirconia beads of at most 1.0 mm and more preferred are zirconia beads of at most 0.5 mm.

In the ink-jet recording sheet of the present invention, the amount of employed wet process silica is about 3-about 30 g per m² of the recording sheet, and is preferably 5-20 g to result in an ink absorption capacity such that during printing, neither ink flooding nor mottling occurs.

Hydrophilic binders according to the present invention will now be described.

In the present invention, it is possible to employ various conventional hydrophilic binders known in the art. Examples include gelatin (acid process gelatin is preferred), polyvinyl alcohol or its derivatives, polyvinylpyrrolidone (preferably at an average molecular weight of approximately 200,000 or more), polyethylene glycol (preferably at an average molecular weight of approximately 100,000 or more), polyethylene oxide, hydroxyethyl cellulose, agar, Pullulan, dextran, dextrin, water-soluble polyvinyl butyral, acrylic acid, carboxymethyl cellulose, casein, and alginic acid. These may be employed in combinations of at least two types. In the present invention, particularly preferred hydrophilic binders are polyvinyl alcohol or its derivatives.

Polyvinyl alcohols, which are preferably employed in the present invention, include modified polyvinyl alcohols such as cation modified polyvinyl alcohol, anion modified polyvinyl alcohol having an anionic group, or silyl modified polyvinyl alcohol substituted with a silyl group.

The average degree of polymerization of polyvinyl alcohols preferably employed in the present invention is preferably at least 300, is more preferably 1,000-5,000, and is most preferably 2,000-4,500. The average molecular weight is preferably at least 1,000, resulting in minimal brittleness of the resulting coating. Further, the saponification ratio is preferably 70-100 mol percent, and is more preferably 80-99.5 mol percent.

Cation modified polyvinyl alcohol is prepared by saponifying a copolymer of ethylenic unsaturated monomers having a cationic group with vinyl acetate. Examples of ethylenic unsaturated monomers having a cationic group include trimethyl-(2-acrylamido-2,2-dimethylethyl)ammonium chloride, trimethyl-(3-acrylamido-3,3-dimethylpropyl)ammonium chloride, N-vinylimidazole, N-vinyl-2-methylimidazole, N-(3-dimethylaminopropyl)methacrylamide, hydroxyethyltrimethylammonium chloride, trimethyl-(methacrylamidopropyl)ammonium chloride, and N-(1,1-dimethyl-3-dimethylaminopropyl)acrylamide.

The ratio of cation modifying group containing monomers in cation modified polyvinyl alcohol is 0.1-10 mol percent with respect to vinyl acetate, and is preferably 0.2-5 mol percent. The degree of polymerization of cation modified polyvinyl alcohol is customarily 500-4,000, and is preferably 1,000-4,000. Further, the saponification ratio of cation modified polyvinyl alcohol is customarily 60-100 mol percent, and is preferably 70-99 mol percent.

In order to form an ink absorptive layer of a void structure, the aforesaid hydrophilic binders are employed in a relatively small amount for the wet process silica. In the range in which the coated layer is stably formed and the adhesion to the support is sufficiently secured, the aforesaid amount is preferably as small as possible.

The present invention is characterized in that the weight ratio (F/B) of the aforesaid minute wet process silica particles (F) to hydrophilic binders (B) is controlled to be 5.5-12. In the aforesaid range, it is possible to achieve compatibility between sufficient ink absorbability and crack resistance during coating and drying. As noted above, it is possible to achieve this effect by controlling the pH of the surface of the coated layer to 3.0-6.0 and preferably 3.5-5.5. Specifically, preferred is a method to control the pH of the ink absorptive layer liquid coating composition. However, other than this method, the aforesaid effect is achieved employing a method in which after coating an ink absorptive layer, a pH controlling liquid composition is overcoated. It is preferable that the pH of a liquid coating composition is controlled by controlling the pH of a wet process silica powdered dispersion. Examples of pH controlling agents include, but are not limited to, nitric acid, phosphoric acid, and citric acid. However, when polyvinyl alcohol is employed as a hydrophilic binder, it is preferable to use boric acid from the viewpoint of capable of providing a function as a crosslinking agent of polyvinyl alcohol. Further, wet process silica which is manufactured in the relatively low pH region results in pH of the water dispersions of 6.0 or less. When such silica is employed, it is not necessary to specifically control the pH, resulting in a layer surface pH in the range of 3.0-6.0.

It is possible to determine the pH of the layer surface according to the present invention based on the method described in J. TAPPI Paper Pulp Test Method No. 49 in which distilled water is used and measurement is carried out after 30 seconds.

In order to prepare the ink-jet recording sheet of the present invention without enhancing brittleness of the layer of a high glossiness and a high void ratio, it is preferable that the aforesaid hydrophilic binders are hardened by hardening agents.

Hardening agents, as described herein, refer to compounds which have a group capable of reacting with the aforesaid hydrophilic binders or compounds which promote reaction between different groups of hydrophilic binders. The aforesaid hardening agents are suitably selected depending on the type of hydrophilic binders and then employed.

Listed as hardening agents usable in the present invention are, for example, epoxy based hardening agents (diglycidyl ethyl ether, ethylene glycol diglycidyl ether, 1,4-butanediol diglycidyl ether, 1,6-diglycidylcyclohexane, N,N-diglycidyl-4-glycidyloxyaniline, sorbitol polyglycidyl ether, and glycerol polyglycidyl ether); aldehyde based hardening agents (formaldehyde and glyoxal); active halogen based hardening agents (2,4-dichloro-6-hydroxy-1,3,5-s-triazine); active vinyl based compounds (1,3,5-trisacryloyl-hexahydro-s-triazine, and bisvinyl sulfonylmethyl ether); and boric acid and salts thereof, borax, and aluminum alum.

When polyvinyl alcohol and/or cation modified polyvinyl alcohol is employed as a hydrophilic binder, it is preferable to employ hardening agents selected from boric acid and salts thereof, and epoxy based hardening agents. The most preferable hardening agents are those selected from boric acid and salts thereof. Boric acids or salts thereof, refer to oxygen acids having a boron atom as a central atom, and salts thereof. Specific examples include orthoboric acid, diboric acid, metaboric acid, tetraboric acid, pentaboric acid, and octaboric acid, and salts thereof.

The used amount of the aforesaid hardening agents varies depending on the type of employed hydrophilic binders, the type of hardening agents, the type of minute wet process silica, and the ratio with respect to hydrophilic binders, but is commonly 5-500 mg per g of the hydrophilic binders, and is preferably 10-400 mg.

When a liquid coating composition which forms a void layer is coated, the aforesaid hardening agents may be incorporated into the liquid coating composition which forms the void layer or the liquid coating composition which forms another layer adjacent to the void layer. Alternatively, it is possible to incorporate hardening agents into the void layer in such a manner that a liquid coating composition which forms the aforesaid void layer is applied onto the support onto which a liquid coating composition comprising hardening agents are applied or after coating and drying a liquid coating composition comprising no hardening agents which forms the void layer, a hardening agent solution is overcoated. However, from the viewpoint of production efficiency, it is preferable that hardening agents are incorporated into a liquid coating composition which forms a void layer or a liquid coating compositions of the layer adjacent to the aforesaid layer, hardening agents are provided at the same time when the void layer is formed.

It is preferable that cation fixing agents are incorporated into the ink-jet recording sheet of the present invention.

Examples of cation fixing agents (also called cationic polymers) according to the present invention include polyethyleneimine, polyallylamine, polyvinyl amine, dicyandiamidopolyalkylene polyamine condensation products, polyalkylene polyamine dicyandiamidoammonium salt condensation products, dicyandiamide formalin condensation products, epichlorohydrin.dialkylamine addition polymers, diallyldimethylammonium chloride polymers, diallyldimethylammonium chloride-SO₂ copolymers, polyvinylimidazole, vinylpyrrolidone-vinylimidazole copolymers, polyvinylpyridine, polyamidine, chitosan, cationic starch, vinylbenzyltrimethylammonium chloride polymers, (2-methacroyloxyethyl)trimethylammonium chloride polymers, and dimethylaminoethyl methacrylate copolymers.

Further, examples also include cationic polymers described in Kagaku Kogyo Jiho (Chemical Industry News), Aug. 15 and 25, 1998 and polymer dye fixing agents described in “Kobunshi Yakuzai Nyumon (Introduction to Polymer Agents)”, published by Sanyo Chemical Industry Co., Ltd.

In the present invention, from the viewpoint of enhancing of bleeding resistance during storage of prints, particularly preferred is Cationic Polymer 1 described below.

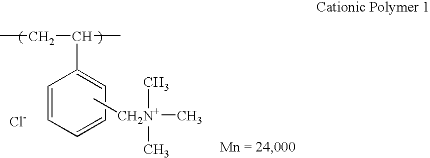

The used amount of cation fixing agents according to the present invention is customarily at most 14 percent by weight with respect to minute wet process silica particles, is preferably at most 10 percent, and is more preferably at most 7 percent. It is preferable to control the aforesaid amount to the above range to maintain the desired ink absorbability. Further, from the viewpoint of achieving the sufficient bleeding resistance, the lower limit of the aforesaid used amount is preferably at least 0.1 percent.

Various additives other than those described above may be employed in the ink absorptive layer of the ink-jet recording sheet of the present invention and other layers which are provided as needed. It is possible to incorporate various additives, known in the art, such as various anionic, cationic, nonionic, and amphoteric surfactants, polyethylene oxide, polyvinylpyrrolidone, casein, starch, agar, carrageenan, polyacrylic acid, polymethacrylic acid, polyacryl amide, polymethacryl amide, polystyrenesulfonic acid, cellulose, hydroxyethyl cellulose, carboxymethyl cellulose, hydroxyethyl cellulose, dextran, dextrin, Pullulan, water-soluble polymers such as water-soluble polyvinyl butyral, boric acid or salts thereof, epoxy based crosslinking agents, (e.g., diglycidyl ethyl ether, ethylene glycol diglycidyl ether, 1,4-butanediol glycidyl ether, 1,6-diglycidylcyclohexane, N,N-diglycidyl-4-glycidyloxyaniline, sorbitol polyglycidyl ether, and glycerol polyglycidyl ether), aldehyde based crosslinking agents (e.g., formaldehyde and glyoxal), active halogen based crosslinking agents (e.g., 2,4-dichloro-4-hydroxy-1,3,5-s-triazine), active vinyl based compounds (e.g., 1,3,5-trisacryloyl-hexahydro-s-triazine and bisvinylsulfonyl methyl ether), aluminum alum, crosslinking agents such as isocyanate based compounds, UV absorbers described in JP-A Nos. 57-74193, 57-87988, and 62-261476; anti-discoloring agents described in JP-A Nos. 57-74192, 57-87989, 60-72785, 61-146591, 1-95091, and 3-13376; optical brightening agents described in JP-A Nos. 59-42993, 59-52689, 62-280069, 61-242871, and 4-219266; pH regulators such as sulfuric acid, phosphoric acid, citric acid, sodium hydroxide, potassium hydroxide, and potassium carbonate; antifoaming agent; antiseptic agents, thickeners; antistatic agents; and matting agents.

An ink absorptive layer on the ink-jet recording sheet of the present invention may be comprised of at least two layers. In such a case, the constitution of these ink absorptive layers may be the same or different.

Employed as supports of the ink-jet recording sheet of the present invention may be water absorptive or non-water absorptive supports. However, non-water absorptive supports are preferred because no wrinkling after printing is formed and the smoothness of images causes no difference, whereby high quality prints are produced.

Water absorptive supports include commonly paper supports, and also fabric and porous film supports.

Further, examples of non-water absorptive supports include films comprised of polyethylene terephthalate resins, polyester based resins, diacetate based resins, triacetate based resins, acryl based resins, polycarbonate based resins, polyvinyl chloride based resins, polyimide based resins, cellophane, and celluloid, metal and glass, and resin coated paper (so-called RC papers) having a polyethylene resin covering layer, and white pet which is prepared by adding white pigments to polyethylene terephthalate.

In the present invention, of these supports, most preferably employed are paper supports which are prepared by laminating both sides of a base paper support with polyethylene because recorded image quality is close to conventional photographic quality and in addition, high quality images are obtained at lower cost.

Supports which are particularly preferred in the present invention will now be described, which are non-water absorptive supports prepared by covering paper with polyolefin resins.

Paper employed in the supports according to the present invention is made employing wood pulp as a main raw material, as well as in addition to the wood pulp, synthetic pulp such as polypropylene or synthetic fiber such as nylon and polyester. Employed as wood pulp may be any of LBKP, LBSP, NBKP, NBSP, LDP, NDP, LUKP, and NUKP. However, it is preferable to use at a higher proportion of LBKP, VBSP, NDP, or LDP which is comprised of shorter fiber component at a larger portion. However, the ratio of LBSP and/or LDP is preferably 10-70 percent. Preferably employed as the aforesaid pulp is chemical pulp (sulfate pulp and sulfite pulp) with minimal impurities. Further, also useful is pulp of which whiteness is enhanced by bleaching.

Into paper, appropriately incorporated may be, for example, sizing agents such as higher fatty acids, or alkylketone dimmers, white pigments such as calcium carbonate, talc, or titanium oxide, paper strength enhancing agents such as starch, polyacryl amide, or polyvinyl alcohol, optical brightening agents, moisture retaining agents such as polyethylene glycol, dispersing agents, and softening agents such as quaternary ammonium.

The freeness of pulp employed for making paper is preferably 200-500 ml under the specification of CSF. Further, regarding fiber length after beating, the sum of 24 mesh residue and 42 mesh residue specified in JIS P 8207 is preferably 30-70 percent. Further, 4 mesh residue is preferably at most 20 percent.

The basis weight of paper is preferably 50-250 g, and is more preferably 70-200 g. The thickness of paper is preferably 50-210 μm.

Paper may be provided with high smoothness by a calendar process during the paper making stage or after paper making. Paper density is commonly 0.7-1.2 g/cm³ (based on JIS P 8118). Further, the stiffness of paper is preferably 20-200 g under the conditions specified by JIS P 8143.

Surface sizing agents may be applied onto the surface of paper. Employed as surface sizing agents may be those which are the same as sizing agents capable of being incorporated into the aforesaid base paper.

The pH of paper is preferably 5-9 when determined employing the hot water extraction method specified in JIS P 8113.

Polyolefin resins which are employed to cover both sides of the aforesaid paper will be described.

Examples of polyolefin resins which are employed to achieve the aforesaid purpose include polyethylene, polypropylene polyisobutylene, and polyethylene. Polyolefins such as copolymers comprised of propylene as a main component are preferred and polyethylene is particularly preferred.

Particularly preferred polyethylene will be described.

Polyethylene which is employed to cover the front surface and/or the back surface of paper is mainly low density polyethylene (LDPE) and/or high density polyethylene (HDPE). However, it is possible to partially employ other LLDPE and polypropylene.

Specifically, it is preferable that rutile type or anatase type titanium oxide is incorporated into the polyolefin layer on the coating layer side to enhance opacity as well as whiteness. The proportion of titanium oxide is customarily 1-20 percent with respect to polyolefin, and is preferably 2-15 percent.

In order to control white background, it is possible to incorporate colored pigments of high heat resistance as well as optical brightening agents into the polyolefin layer. Examples of colored pigments include ultramarine, Prussian blue, cobalt blue, phthalocyanine blue, manganese blue, cerulean, tungsten blue, molybdenum blue, and anthraquinone blue, while examples of optical brightening agents include dialkylaminocoumarin, bisdimethylaminostilbene, bismethylaminostilbene, 4-alkoxy-1,8-naphthalenedicarboxylic acid-N-alkylimide, bisbenzoxazolylethylene, and dialkylstilbene.

The amount of polyethylene used on the front side and reverse side of paper is determined so that curling is minimized under low and high humidity at the specified thickness of the ink absorptive layer or after providing the back layer. Commonly, the thickness of a polyethylene layer is 15-50 μm on the ink absorptive later side, while it is 10-40 μm on the back layer side. It is preferable that the ratio of polyethylene on the front side to the reverse side is determined to control curling which varies depending on the type and thickness of the ink absorptive layer as well as the thickness of the core paper. The ratio of polyethylene on the front side to the reverse side is commonly 3/1-1/3 in term of thickness.

Further, it is preferable that the aforesaid polyethylene coated paper support exhibits characteristics of items (1)-(7).

(1) Tensile strength is preferably 19.6-294 N in the longitudinal direction and 9.8-196 kg in the lateral direction, in terms of the strength specified in JIS P 8113.

(2) Tear strength specified in JIS P 8116 is preferably 0.20-2.94 N in the longitudinal direction and 0.098-2.45 N in the lateral direction.

(3) Compression modulus of elasticity is preferably 9.8 kN/cm².

(4) Opacity is preferably at least 80 percent, and is most preferably 85-98 percent, when determined employing the method specified in JIS P 8138.

(5) Whiteness preferably exhibits L*, a*, and b* specified in JID Z 8727 to be L*=80-96, a*=−3-+5, and b*=−7-+2.

(6) Clark stiffness of the support is preferably 50-300 cm²/100 in the recording sheet transporting direction.

(7) Moisture of base paper is preferably 4-10 percent by weight with respect to the core paper.

(8) Glossiness (75-degree secular gloss) to be provided with an ink absorptive layer is preferably 10-90 percent.

Preferably employed as coating systems usable in the production of the ink-jet recording sheet of the present invention are, for example, a roller coating method, a rod bar coating method, an air knife coating method, a spray coating method, a curtain coating method, or an extrusion coating method, described in U.S. Pat. No. 2,681,294, which uses a hopper.

The temperature of liquid coating compositions is commonly 25-60° C., is preferably 35-50° C., and is more preferably 36-48° C. Cooling is carried out by passing the coating through a cooling-zone for a definite time (preferably at least 5 seconds) so that after coating, the surface temperature of the coating reaches 20° C. or less and prefersbly 15° C. or less. From the viewpoint of minimizing the unevenness of the coating, it is preferable that during the aforesaid cooling period, air is not blown excessively. Form the viewpoint of resulting in a uniform layer surface, it is preferable that drying after cooling is carried out by blowing 20° C. or higher air. It is particularly preferable that drying is carried out in such a manner that initially, 20° C. or higher air is blown and thereafter, the temperature of the air increases gradually. Though drying time varies depending on total wet layer thickness, drying is finished within approximately 10 minutes and is preferably finished within 5 minutes.

When image recording is carried out employing the ink-jet recording sheet of the present invention, a recording method employing an aqueous ink is preferably employed. Further, it is preferable to use a water-soluble dye ink as the aqueous ink, because it is possible to effectively achieve targeted purposes of the present invention. On the other hand, it is possible to use pigment inks for ink-jet recording.

The aqueous ink, as described in the present invention, refers to the recording liquid comprising coloring agents and liquid media described below, as well as other additives.

Employed as coloring agents may be direct dyes, acidic dyes, basic dyes, and reactive dyes known in the art, water-soluble dyes such as food dyes, or water dispersible pigments.

Listed as solvents for aqueous inks are, for example, water and various water-soluble organic solvents including alcohols such as methyl alcohol, isopropyl alcohol, butyl alcohol, tert-butyl alcohol, isopropyl alcohol, or isobutyl alcohol; amides such as dimethylformamide or dimethylacetoamide; ketones or ketone alcohols such as acetone or diacetone alcohol; ethers such as tetrahydrofuran or dioxane; polyalkylene glycols such as polyethylene glycol or polypropylene glycol; polyhydric alcohols such as ethylene glycol, propylene glycol, butylene glycol, triethylene glycol, 1,2,6-hexanetriol, thiodiglycol, hexylene glycol, diethylene glycol, glycerin, or triethanolamine; lower alkyl ethers of polyhydric alcohols such as ethylene glycol methyl ether, diethylene glycol methyl (or ethyl) ether, or triethylene glycol monbobutyl ether. Of these, preferred are polyhydric alcohols such as diethylene glycol, triethanolamine, or glycerin, as well as lower alkyl ethers of polyhydric alcohols such as triethylene glycol monobutyl ether.

Examples of other aqueous ink additives include pH regulators, sequestering agents, mildewcides, viscosity modifiers, surface tension regulators, humectants, surfactants, and anti-corrosive agents.

In order to enhance wettability of an aqueous ink liquid to recording sheets, its surface tension is controlled to be commonly in the range of 25-60 mN/m and preferably in the range of 30-50 mN/cm. The pH of the aforesaid ink is preferably 5-10, and is more preferably 6-9.

### EXAMPLES

The effects of the present invention will specifically be described with reference to examples. However, the embodiments of the present invention are not limited thereto. “%” described in the examples is % by weight unless otherwise specified. Further, binders or their total weight during preparation of recording sheets refers to polyvinyl alcohol and the total weight of emulsion resins, respectively.

### Example 1

<<Preparation of Silica Dispersions S-1-S-11>>

While stirring, gradually added to 820 ml of a one percent aquesous ethanol solution was 125 g of each of the minute silica particles described in Table 1, and the resulting mixture was dispersed employing a high speed stirring homogenizer. Except for S-1, the pH of the resulting dispersion was controlled and the total volume was adjusted to 1,000 ml by adding pure water. Subsequently, Silica Dispersions S-1-S-11 shown in Table 2 were prepared by suitably changing dispersion time while employing a sand mill. Incidentally, the pH of S-2 and S-3 was controlled by nitric acid, while the pH of S-4-S-11 was controlled by nitric acid after adding 50 ml of a 50 percent aqueous boric acid solution. Each of the resulting dispersions was filtered employing a TCP-10 type filter, manufactured by Advantex Toyo Co. Further, the secondary average diameter of minute silica particles of the silica dispersion shown in Table 1 was determined employing a light scattering spectrophotometer (manufactured by Otsuka Electronics Co., Ltd.) after diluting each silica dispersion by a factor of 50.

| | | | | TABLE1 | | | |
|---|---|---|---|---|---|---|---|
| | | | | Characteristics of Minute Silica Particles | | | |
| | | Average | | | | | Average |
| | | Diameter | | | | | Diameter |
| | | of | | | | | of |
| Silica | | Secondary | | | | | Primary |
| Dispersion | pH of | Particles | | Product | | Production | Particles |
| No. | Dispersion | (nm) | pH Moderator | Name | Manufacturer | Method | (nm) |
| S-1 | 7.0 | 223 | — | Nipgel | *1 | *3 | 10 |
| | | | | AZ200 | | | |
| S-2 | 5.8 | 221 | Nitric Acid | Nipgel | *1 | *3 | 10 |
| | | | | AZ200 | | | |
| S-3 | 4.3 | 189 | Nitric Acid | Nipgel | *1 | *3 | 10 |
| | | | | AZ200 | | | |
| S-4 | 4.3 | 190 | Nitric Acid, | Nipgel | *1 | *3 | 10 |
| | | | Boric Acid | AZ200 | | | |
| S-5 | 2.9 | 188 | Nitric Acid, | Nipgel | *1 | *3 | 10 |
| | | | Boric Acid | AZ200 | | | |
| S-6 | 2.5 | 195 | Nitric Acid, | Nipgel | *1 | *3 | 10 |
| | | | Boric Acid | AZ200 | | | |
| S-7 | 4.3 | 294 | Nitric Acid, | Nipgel | *1 | *3 | 10 |
| | | | Boric Acid | AZ200 | | | |
| S-8 | 4.3 | 343 | Nitric Acid, | Nipgel | *1 | *3 | 10 |
| | | | Boric Acid | AZ200 | | | |
| S-9 | 4.3 | 232 | Nitric Acid, | X37B | *2 | *4 | 10 |
| | | | Boric Acid | | | | |
| S-10 | 4.3 | 198 | Nitric Acid, | X45 | *2 | *4 | 15 |
| | | | Boric Acid | | | | |
| S-11 | 4.3 | 210 | Nitric Acid, | Nipgel | *1 | *4 | 10 |
| | | | Boric Acid | E-75 | | | |

*1; Nippon Silica Industrial Co., Ltd.
*2; Tokuyama Corp.
*3; Gelling Method Wet Process Silica
*4; Precipitation Method Wet Process Silica

<<Preparation of Recording Sheets>>

While stirring at 45° C. added to each of Silica Dispersions S-1-S-11 prepared as above was a 10% aqueous polyvinyl alcohol (PVA235, manufactured by Kuraray Co., Ltd.) solution to result in the solid weight ratio shown in Table 2. Subsequently, pure water was added to result in a silica solid weight ratio of 9%, whereby each absorptive layer liquid coating composition was prepared. Incidentally, Table 2 shows the weight ratio (F/B) of minute silica particles (F) to polyvinyl alcohol (B) which is the hydrophilic binder in the aforesaid ink absorptive layer liquid coating composition.

Subsequently, aforesaid Ink Absorptive Layer Liquid Coating Composition 1 was applied onto the recording surface side of a basis weight 180 g/m² support (of a thickness of 250 μm and incorporating anatase type titanium of a 6 weight percent on both sides) employing a wire bar under conditions which resulted in a wet layer thickness in terms of silica coverage of 16 g/m². Immediately after coating, the resulting coating was cooled for 20 seconds in a 4° C. cooling zone and thereafter, was successively dried employing air flow of which temperature was varied from 20 to 65° C. through several stages, whereby Recording Sheets 1-1-1-15 were prepared.

<<Evaluation of Recording Sheets>>

Each of the Recording Sheets 1-1-1-15, prepared as above, was subjected to each characteristic evaluation employing the methods described below.

(Measurement of Average Diameter of Secondary Silica Particles)

The section as well as the surface of the ink absorptive layer of each recording sheet was observed, employing an electron microscope, and the diameter of each of the 100 randomly selected silica particles was determined. The resulting values were averaged and the average thus obtained was designated as the average diameter of secondary particles. Further, each particle diameter was expressed by the diameter of a circle which had the same area as the projection area of the particle.

(Evaluation of Ink Absorbability)

A solid green image was printed on each recording sheet using a genuine aqueous ink while employing an ink-jet printer PM-800, manufactured by Epson Corp. Immediately after printing, a solid image portion was rubbed with fingers and image non-uniformity was visually evaluated. Ink absorbability was then evaluated based on the criteria below.

A: When rubbed with fingers, no image uniformity was degraded.

B: When rubbed with fingers, image uniformity was slightly degraded.

C: When rubbed with fingers, image uniformity was partially degraded but remained to be readable.

D: The entire image was smeared to result in staining and no original image remained

(Evaluation of Crack Resistance)

The number of cracks of 5 μm or more was determined with respect to 10×10 cm² of each recording sheet. Subsequently, crack resistance was evaluated based on the criteria below.

A: No cracks were formed.

B: The number of formed cracks was 1-3.

C: The number of formed cracks was 4-9.

D: The number of formed cracks was at least 10.

(Determination of Print Density)

A black solid image was printed on each of the recording sheets using a genuine aqueous ink while employing an ink-jet printer PM800, manufactured by Seiko Epson Co., Ltd.

Subsequently, reflection density was determined.

(Determination of Glossiness)

Glossiness at 75 degrees of the aforesaid solid black image was determined employing a variable angle glossmeter (VGS-1001DP), manufactured by Nippon Denshoku Industries Co., Ltd.

Table 2 shows each of the evaluation results.

TABLE 2

| | | | | | | Average | | | | | |
|---|---|---|---|---|---|---|---|---|---|---|---|
| | | | | | | Diameter | | | | | |
| | Silica | | | | | of | | | | | |
| | Particles | | *PVA | | | Secondary | | | | | |
| Recording | | Solid | Solid | | Layer | Silica | | | | | |
| Sheet | | Ratio | Ratio | | Surface | Particles | Ink | Glossiness | Print | Crack | |
| No. | Dispersion | (%) | (%) | F/B | pH | (nm) | Absorbability | (%) | Density | Resistance | Remarks |
| 1-1 | S-1 | 83.4 | 16.6 | 5.0 | 7.3 | 232 | D | 55 | 1.98 | B | Comp. |
| 1-2 | S-1 | 90.0 | 10.0 | 9.0 | 7.3 | 230 | B | 38 | 1.89 | D | Comp. |
| 1-3 | S-2 | 90.0 | 10.0 | 9.0 | 6.0 | 229 | B | 54 | 2.15 | B | Inv. |
| 1-4 | S-3 | 90.0 | 10.0 | 9.0 | 4.5 | 211 | A | 55 | 2.25 | B | Inv. |
| 1-5 | S-4 | 90.0 | 10.0 | 9.0 | 4.6 | 204 | A | 56 | 2.23 | B | Inv. |
| 1-6 | S-5 | 90.0 | 10.0 | 9.0 | 3.1 | 199 | A | 56 | 2.25 | B | Inv. |
| 1-7 | S-6 | 90.0 | 10.0 | 9.0 | 2.5 | 200 | B | 40 | 2.24 | D | Comp. |
| 1-8 | S-4 | 86.7 | 13.3 | 6.5 | 4.6 | 203 | A | 55 | 2.25 | A | Inv. |
| 1-9 | S-4 | 84.6 | 15.4 | 5.5 | 4.6 | 205 | B | 54 | 2.24 | A | Inv. |
| 1-10 | S-4 | 83.3 | 16.7 | 5.0 | 4.6 | 207 | C | 55 | 2.24 | A | Comp. |
| 1-11 | S-7 | 86.7 | 13.3 | 6.5 | 4.5 | 294 | A | 52 | 2.16 | A | Inv. |
| 1-12 | S-8 | 86.7 | 13.3 | 6.5 | 4.5 | 352 | A | 44 | 1.90 | B | Comp. |
| 1-13 | S-9 | 86.7 | 13.3 | 6.5 | 4.6 | 228 | A | 55 | 2.14 | A | Inv. |
| 1-14 | S-10 | 86.7 | 13.3 | 6.5 | 4.5 | 228 | B | 52 | 1.92 | A | Comp. |
| 1-15 | S-11 | 86.7 | 13.3 | 6.5 | 4.6 | 219 | C | 50 | 1.83 | A | Comp. |

*PVA: polyvinyl alcohol
Comp.; Comparative Example
Inv.; Present Invention

As can clearly be seen from Table 2, the recording sheets comprising the ink absorptive layer, which were constituted as specified by the present invention, exhibited excellent crack resistance, ink absorbability, and glossiness, and resulted in high print density. On the other hand, the comparative recording sheets did not achieve any of desired performance such as poor crack resistance due to low layer strength or low print density.

### Example 2

<<Preparation of Recording Sheets>>

(Preparation of Recording Sheet 2-1: Comparative Example)

Added to 860 ml of a 0.6% aqueous ethanol solution were 81 g of a 28% aqueous cationic polymer (previously exemplified Cationic Polymer 1) solution, 4.3 g of boric acid, and 3.1 g of borax. Subsequently, 190 g of vapor phase method silica (product name: Aerosil 300 of an average diameter of primary particles of 7 nm, manufactured by Nippon Aerosil Co. Ltd.) was gradually added, and the resulting mixture was dispersed employing a high speed homogenizer. The total volume was then adjusted to 1,000 ml. The resulting dispersion was further dispersed employing a sand mill and subsequently was filtered employing a Type TCP-10 filter, manufactured by Advantex Toyo Co., Ltd. The resulting filtrate was designated as Dispersion A.

While stirring at 45° C., 154 ml of a 10% aqueous polyvinyl alcohol (product name: PVA235, manufactured by Kuraray Co., Ltd.) solution was added to 485 ml of aforesaid Dispersion A and a surfactant (saponin) was also added. Subsequently, pure water was added so that the viscosity reached 40 cp at 45° C., whereby a translucent ink absorptive layer liquid coating composition was prepared.

Subsequently, the aforesaid ink absorptive layer liquid coating composition was applied onto the recording surface side of a basis weight 180 g/m² support (of a thickness of 250 μm and incorporating anatase type titanium of a 6 weight percent on the recording surface side) employing a slide hopper coater under conditions which resulted in a wet layer thickness in terms of silica coverage of 16 g/m². Immediately after coating, the resulting coating was cooled for 20 seconds in a 0° C. cooling zone and thereafter, was successively dried employing air flow of which temperature was varied from 20 to 65° C. through several stages, and subsequently rehumidified for two minutes in an ambience of 20-25° C. and 40-60 percent relative humidity. The resulting sample was wound, whereby Recording Sheet 2-1 was prepared. The pH of the layer surface of Recording Sheet 2-1 was 4.6.

(Preparation of Recording Sheet 2-2: Comparative Example)

Recording Sheet 2-2 was prepared in the same manner as aforesaid Recording Sheet 2-1, except that the added amount of the 28% aqueous Cationic Polymer 1 solution was varied to 40 g, and the pH of the primary dispersion prepared employing the homogenizer was adjusted to 4.3 by adding nitric acid. The pH of the resulting layer surface was 4.7.

(Recording Sheet 2-3: Present Invention)

Recording Sheet 2-3 was prepared in the same manner as aforesaid Recording Sheet 2-2, except that the vapor phase method silica employed in Dispersion A was replaced with wet process silica (Nipgel AZ200, gelling method wet process silica, of an average diameter of primary particles of 10 nm, manufactured by Nippon Silica Industrial Co., Ltd.).

<<Evaluation of Recording Sheets>>

In addition to evaluation items described in Example 1, Recording Sheets 2-1-2-3, prepared as above, were subjected to evaluation of bleeding resistance of print images based on the method below.

(Evaluation of Bleeding Resistance of Print Images)

Approximately 0.3 mm wide and M and K lines were printed on each sample employing a genuine aqueous dye ink, while using an ink-jet printer PM800C, manufactured by Seiko Epson Corp. After allowing the printed samples to stand for 5 minutes, they were placed in a clear file and stored for 30 days. After the storage, each line width was determined employing a microdensitomer and the increase ratio of the line width (line width after storage/line width prior to storage) was determined.

Table 3 shows each of the evaluation results.

TABLE 3

| | | Average | | | | | | | |
|---|---|---|---|---|---|---|---|---|---|
| | | Diameter | | | | | | | |
| | | of | | | | | | | |
| | | Secondary | | | | | | | |
| | | Silica | | | | | Bleeding | | |
| Recording | Silica | Particles | Ink | Glossiness | Print | Crack | Resistance | | |
| Sheet No. | Type | (nm) | Absorbability | (%) | Density | Resistance | M | K | Remarks |
| 2-1 | Vapor | 36 | C | 55 | 2.26 | B | 1.27 | 1.35 | Comp. |
| | Phase | | | | | | | | |
| | Method | | | | | | | | |
| | Silica | | | | | | | | |
| 2-2 | Vapor | 39 | A | 54 | 2.25 | A | 1.89 | 2.02 | Comp. |
| | Phase | | | | | | | | |
| | Method | | | | | | | | |
| | Silica | | | | | | | | |
| 2-3 | Wet | 189 | A | 54 | 2.25 | A | 1.19 | 1.30 | Inv. |
| | Process | | | | | | | | |
| | Silica | | | | | | | | |

Comp.; Comparative Example
Inv.; Present Invention

As can clearly be seen from Table 3, the recording sheet of the present invention exhibited superior bleeding resistance due to the cation fixing agent to Comparative Examples. Namely, when Recording Sheet 2-2 is compared to Recording Sheet 2-3, the content of the cation fixing agent was the same. However, Recording Sheet 2-3 of the present invention exhibited better bleeding resistance. On the other hand, Recording Sheet 2-1 in which in order to enhance the bleeding resistance, a larger amount of the cation fixing agent was added than Recording Sheet 2-1 resulted in a decrease in ink absorbability, even though exhibiting excellent bleeding resistance.

According to the present invention, it is possible to provide an ink-jet recording sheet which exhibits high ink absorbability, glossiness, and print density, and results in excellent crack resistance due to formation of a flexible ink absorptive layer and in which it is possible to enhance bleeding resistance while maintaining the high ink absorbability even though cation fixing agents are added.

What is claimed is:

1. An ink-jet recording sheet comprising a support having thereon an ink receiving layer containing a silica particle prepared by a wet method and a hydrophilic binder,
wherein the silica particle has an average diameter of a primary particle of not more than 10 nm and an average diameter of a second particle diameter of 10 to 300 nm; a weight ratio of the silica particle to the hydrophilic binder is 5.5:1 to 12:1; and the ink receiving layer has a surface pH value of 3.0 to 6.0.

2. The ink-jet recording sheet of claim 1,
wherein the silica particle is prepared by a gelling method.

3. The ink-jet recording sheet of claim 1,
wherein the hydrophilic binder is a polyvinyl alcohol or a polyvinyl alcohol derivative.

4. The ink-jet recording sheet of claim 1,
wherein the ink receiving layer contains a cationic compound for fixing a colorant in the ink.

5. The ink-jet recording sheet of claim 1,
wherein the support is non-water absorptive.
